(19) United States
(12) Patent Application Publication
(10) Pub. No.: US 2007/0063549 A1
(43) Pub. Date: Mar. 22, 2007

(54) Tractor cabs

(75) Inventors: Bruno Sap, Beauvais (FR); Malcolm Shute, St Germain La Poterie (FR); Bertrand Budin, Haudivllers (FR); Jean Andiano, Oroer (FR)

Correspondence Address: TROUTMAN SANDERS LLP, 600 PEACHTREE STREET , NE, ATLANTA, GA, 30308, US

(73) Assignee: AGCO SA, Beauvais (FR)

(21) Appl. No.: 11/522,797

(22) Filed: Sep. 18, 2006

(30) Foreign Application Priority Data
Sep. 20, 2005 (GB) GB0519129.1

(51) Int. Cl. B60J 7/043

(52) U.S. Cl. 296/216.01; 296/216.02

(57) ABSTRACT

A tractor cab roof (10) has a first area of glass (11) adjacent a front edge 912) of the roof and a second area of glass (13) adjacent a rear edge (14) of the roof, and an air conditioning/ventilation unit (15) is located between the two areas of glass. One or both areas of glass (11, 13) can be opened for further ventilation and are provided with gas struts 22, 23 to support the glass in an open position. The air conditioning/ventilation unit (15) may be located centrally in a transverse sense relative to the cab roof or alternatively the air conditioning/ventilation unit (15) can be split into two parts which are located towards the sides (18) of the cab roof to minimise the effect of the unit on the visibility through the two glass areas (11,13). The air conditioning/ventilation unit is housed in the roof about a head lining (17) of the roof, the lower surface of the head lining being angled upwardly (17a, 17b) towards the first and second areas of glass (11,13) to further improve visibility through the glass area.

This invention relates to tractor cabs and in particular to the design of the roofs of such cabs.

It is an object of the present invention to provide a cab with a roof which includes an air conditioning/ventilation unit and an area of glass for improved visibility.

Thus according to the present invention there is provided a tractor cab which has a roof with a first area of glass adjacent a front edge of the roof and a second area of glass adjacent a rear edge of the roof, and an air conditioning/ventilation unit located between the two areas of glass.

As will be appreciated such a cab has greatly improved visibility both forward and rearward of the cab so that the tractor drive has a virtually uninterrupted upward view of implements carried on the front and rear of the tractor.

On or both areas of glass may be openable for further ventilation.

The or each openable glass area may provided with one or more gas struts to support it in an open position.

The air conditioning/ventilation unit may be located centrally in a transverse sense relative to the roof.

The air conditioning/ventilation unit may be housed in the roof above a head lining of the roof, the lower surface of the head lining being angled upwardly towards the first and second areas of glass to further improve visibility through the glass areas.

In an alternative arrangement the air conditioning/ventilation unit is split into tow parts which are located towards the sides of the cab roof to minimise the effect of the unit on the visibility through the two glass areas.

One embodiment of the present invention will now be described, by way of example only, with reference to the accompanying drawings in which:

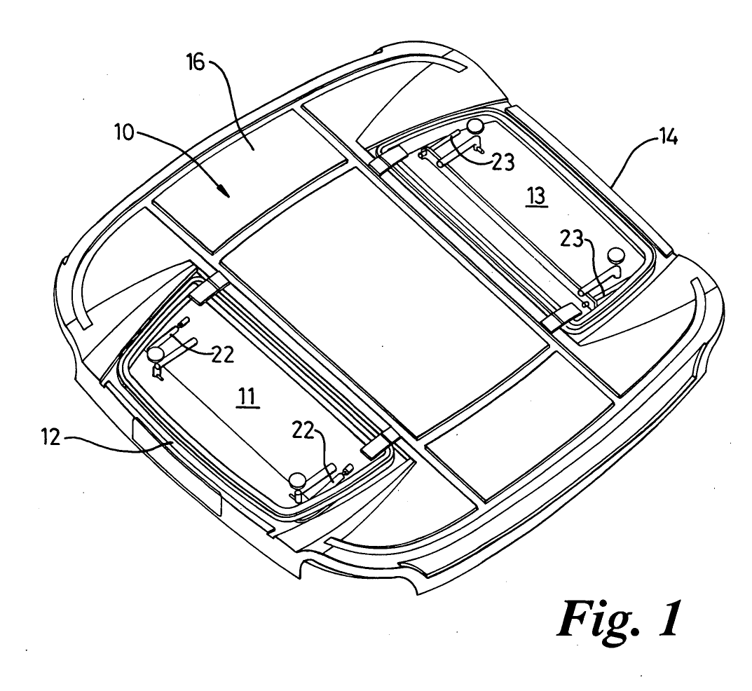

FIG. 1 is perspective plan view of a roof of a tractor cab in accordance with the invention;

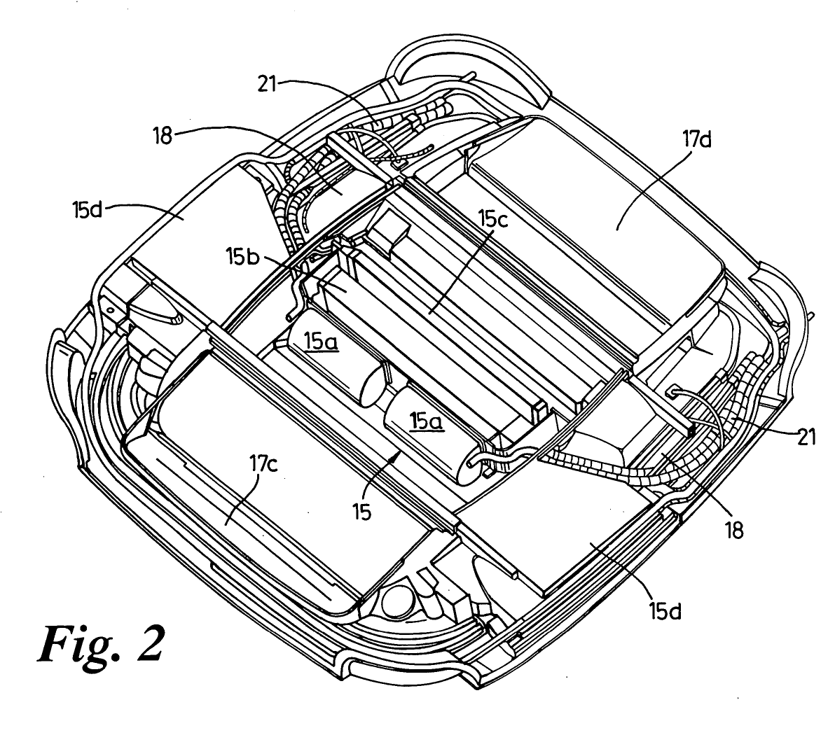

FIG. 2 is a perspective view of the roof of FIG. 1 with the upper outer skin of the roof removed;

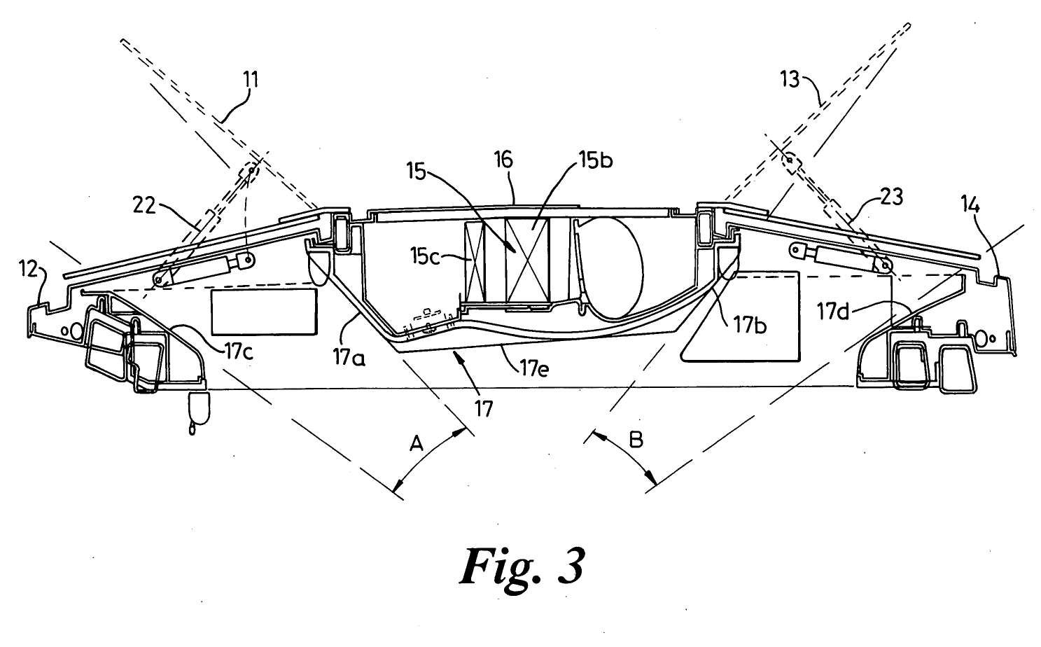

FIG. 3 is a longitudinal section through the roof of FIG. 1;

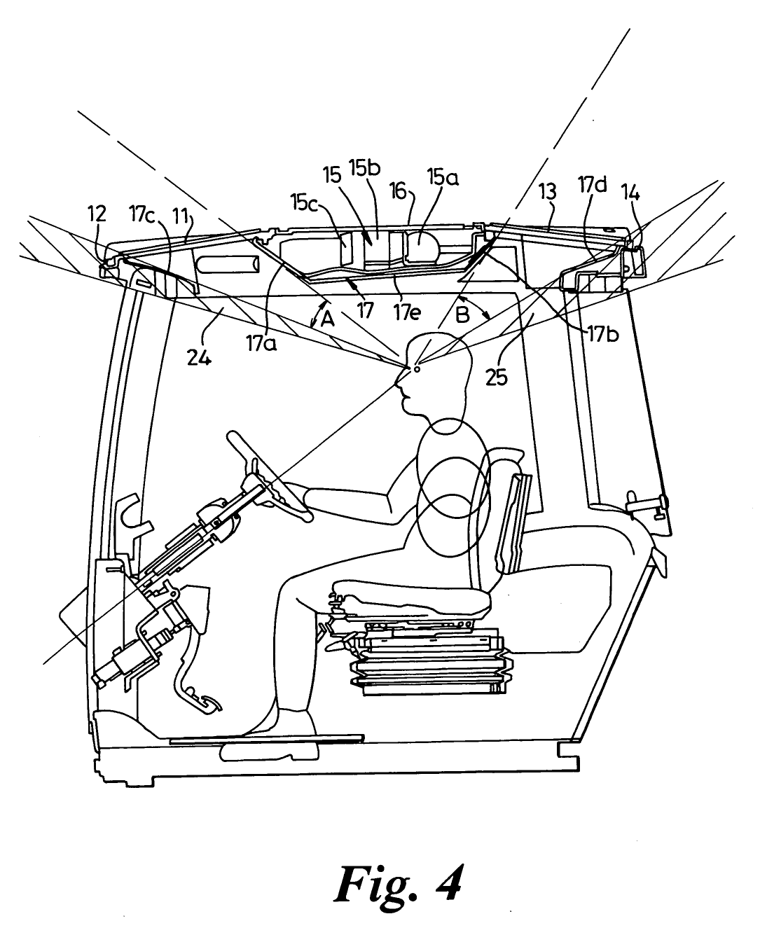

FIG. 4 is a longitudinal section through a tractor cab fitted with the roof of FIGS. 1 to 3, and

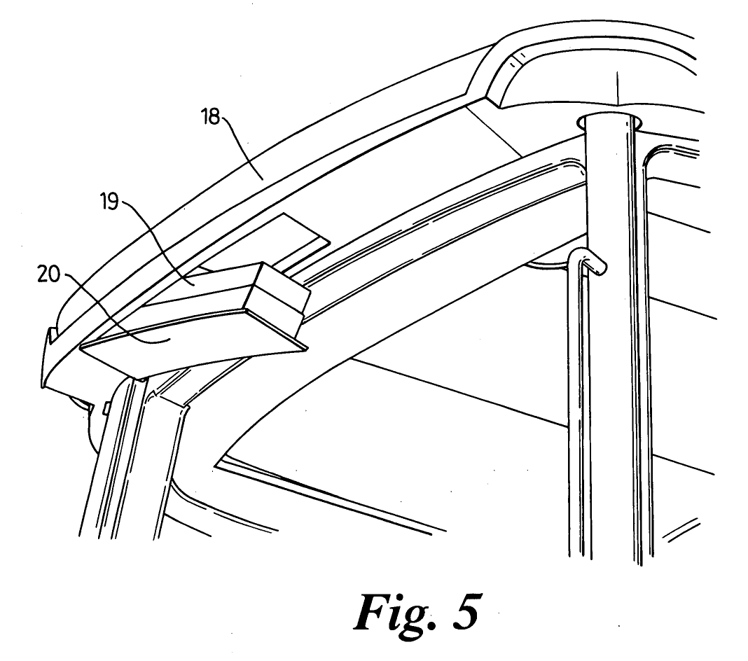

FIG. 5 is a view of an air filter arrangement used in the roof of FIGS. 1 to 3.

Referring to the drawings, a tractor cab roof 10 has a first area of glass 11 adjacent a front edge 12 of the roof and a second area of glass 13 adjacent a rear edge 14 of the roof. Inside the roof an air conditioning/ventilation unit 15 is located between the two areas of glass. This air conditioning/ventilation unit is located between the upper outer metal skin 16 of the roof and a head lining 17 and includes fans 15a, evaporator 15b, heating radiator 15c and recirculating air ducts 15d.

As best seen in FIG. 4, the head lining 17 is angled upwardly at 17a and 17b towards the first and second areas of glass 11 and 13 to further improve the visibility of the driver through the first and second areas of glass. Similarly the lower areas 17c and 17d of the head lining are also angled upwardly to improve visibility. FIG. 4 shows the angle of visibility A through the front first area of glass 11 and angle of visibility B to the rear second glass area 13.

As can be seen from FIGS. 3 and 4 the central region 17e of head lining 17 is the lowest point of the head lining which houses part of the air conditioning/ventilation unit 15. Other components of the air conditioning/ventilation unit are disposed in the side regions 18 of the roof part of which overhangs the cab, as can be seen from FIG. 5.

In the arrangement shown in FIG. 5, an air filter 19 for the air conditioning/ventilation unit is housed above a trap door 20 and is accessed by lowering the trap door whereupon the air filter 19 can be removed for cleaning without the risk of any debris falling inside the cab.

As is clearly visible in FIG. 2, the piping 21 for the air conditioning/ventilation unit is located in the side areas 18 of the roof to minimise the intrusion of the unit into the interior space of the cab.

Both of the areas of glass 11 and 13 are provided with gas struts 22 and 23 respectively for holding the glass areas in an open position as indicated in FIG. 3.

In an alternative construction (not shown) the air conditioning/ventilation unit maybe housed largely in the side areas 18 of the roof to reduce the intrusion of the unit into the interior space of the cab.

As is conventional, the head lining 17 may include inlets or outlets for air which connect with the air conditioning/ventilation unit.

As will be appreciated by providing the tractor cab with front and rear areas of glass 11 and 13 and by suitably locating the air conditioning/ventilation unit to minimize the effect of the presence on visibility through the glass areas the field of view of the tractor driver is greatly improved. Thus, as shown in FIG. 4, only in the shaded areas 24 and 25 is the driver's field of vision obscured.

1. A tractor cab having a roof with a first area of glass adjacent a front edge of the roof and a second area of glass adjacent a rear edge of the roof, and an air conditioning/ventilation unit located between the two areas of glass.

2. A cab according to claim I in which one or both areas of glass can be opened for further ventilation.

3. A cab according to claim 2 in which the or each openable glass area is provided with one or more gas struts to support it in an open position.

4. A cab according to claim I in which the air conditioning/ventilation unit is location centrally in a transverse sense relative to the cab roof.

5. A cab according to claim I in which the air conditioning/ventilation unit is split into two parts which are located towards the sides of the cab roof to minimise the effect of the unit on the visibility through the two glass areas.

6. A cab according to claim I in which the air conditioning/ventilation unit is housed in the roof above a head lining of the roof, the lower surface of the head lining being angled upwardly towards the first and second areas of glass to further improve visibility through the glass areas.
